(19) United States
(12) Patent Application Publication
(10) Pub. No.: US 2002/0133438 A1
(43) Pub. Date: Sep. 19, 2002

(54) AdPix - viewer initiated ad selection

(76) Inventor: Michael Tarr, Malibu, CA (US)

Correspondence Address: MICHAEL TARR, 3465 ENCINAL CYN. RD., MALIBU, CA, 90265, US

(21) Appl. No.: 10/001,033

(22) Filed: Nov. 2, 2001

Related U.S. Application Data
(60) Provisional application No. 60/245,696, filed on Nov. 2, 2000.

(51) Int. Cl. G06F 17/60

(52) U.S. Cl. 705/35

(57) ABSTRACT

A computer implemented database system, capable of residing on several web sites, that allows users to review advertising in defined categories and elect to review particular advertisements and receive redeemable “points” or rewards for reviewing the advertising. In addition, each user is profiled dynamically in order to offer the user the most likely database of advertising of interest to the user.

### CROSS-REFERENCE TO RELATED APPLICATION

This application claims the benefit under 35 U.S.C. §119(e) of co-pending and commonly-assigned U.S. Provisional application serial No. 60/245,696, entitled “VIEWER INITIATED AD SELECTION”, filed Nov. 2, 2000, by Michael Tarr, attorney's docket number VISA0002PR, which application is incorporated by reference herein.

### BACKGROUND OF THE INVENTION

1. Field of the Invention

The present invention relates generally to distributing digital media assets, and in particular, to a method and apparatus, for organizing, distributing, storing, and providing access to advertising messages which may incorporate still photographs, animations, graphics, motion picture or video imagery all in digital form over a network such as the Internet for the purpose of communicating, promoting, selling, providing services or educating.

The invention provides a “context”, including a graphical user interface designed for digital media assets.

2. Description of the Related Art

Currently, advertising exists on the Internet in the form of “banners” or at times TV commercials that are broadcast on the Internet or inserted into other media whether it be news programming, sports programming or entertainment programming on the Internet. These forms of advertising on the Internet are presented to the viewer whether or not the viewer wants the advertising. If the viewer wants more information or desires to see the entire ad or a related web site, the viewer can click on the banner and be directed to additional information.

This current form of advertising on the Internet is ineffectual and intrusive, thus failing to provide the impetus and reasons why advertisers will continue to advertise on the Internet. The forms of advertising on the Internet are very poor copies of other forms of media advertising such as on television or in magazines. Thus, there exists a need for a form of advertising that is suitable for the new environment that has evolved within the Internet itself, especially as that environment evolves toward broadband deployment of Internet digital information.

### SUMMARY OF THE INVENTION

To address the requirements described above, the present invention comprises a computer implemented database system, capable of residing on several web sites that allows viewer/users to review potential advertising categories presented to them and if they so elect, choose to review a particular advertisement or several advertisements. The viewers receive redeemable “points” for reviewing the ads. Said points accumulate and the viewer/user may; redeem those points through the system to purchase any number of products or services.

The system requires each viewer, in order to accumulate and redeem points, to register with the system and provide certain information which in turn helps the system and its advertising clients organize which advertisements to present as available first for a particular viewer. This profiling system is dynamic and accommodates on a regular basis the changing choices the viewer may make as well as the advertising mix that is available at any time on the system.

### DETAILED DESCRIPTION OF THE PREFERRED EMBODIMENT

AdPix is an advertising, distribution and micropayment application designed to capitalize on the $250 billion spent on advertising annually. AdPix licenses their proprietary technology to businesses such as content providers, advertisers and the media industry to run advertising content, video, TV commercials, business presentations, feature films or other intellectual property. Under this model, consumers choose what content they want to review (and receive “frequent users rewards” for so doing) allowing advertisers access to an audience truly interested in their particular product or offering. Additionally, AdPix provides controlled distribution of information and controlled compensation for intellectual property.

AdPix represents a cogent solution to the most pervasive and disturbing problem modern advertisers face: how to deliver advertising messages through rising technological barriers to the most desirable targets—proactive and interactive consumers.

AdPix removes the ubiquitous restraints of time, space and content of print, radio and TV ads. It allows the user to choose what he will watch and when he wishes to watch it. AdPix enables users to avoid the irritation and interference of banner and pop-up ads, while continuing to serve as a portal to draw the user deep into a company's product and encourage that product's purchase.

\Revenue Sources—Advertisers—Distribution

The Internet is growing and evolving at a pace heretofore unimaginable to advertisers. In 2000, there were an estimated 327 million Internet users worldwide. By 2005, that number will reach 1 billion (IDC March, 2000). Advertisers must focus considerable resources on this enormous and ever-growing Internet consumer base. As such, online advertising is expected to reach $28 billion by the year 2005 (Jupiter Research, June, 2000). The U.S. forecast of $16.5 billion will surpass Yellow Pages ($16 billion) and magazine advertising (13.2 billion).

Presently however, advertisers have been unable to effectively reach online viewers. After only a few short years, the click-through rate of Internet based banner ads (the most common method used to measure a banner's effectiveness) has plummeted from 30% to approximately 0.57%. This number is likely to drop even further as more and more banner ads inundate the Web, leaving advertisers scrambling for new and innovative online advertising alternatives.

Visaeons Corporation's technologies offer the logical alternative to the failing banner ad. Visaeons' AdPix application will allow advertisers to reach their target consumers by facilitating the delivery of engaging rich media advertisements and presentations while placing control in the hands of the individual users. In doing so, advertisers ensure that they reach individuals who are genuinely interested in their product or service. There is absolutely no waste.

Further, with profiling and tracking technologies, Visaeons can track user information and activity, ensure that individuals are watching advertisers' presentations and monitor users' post-presentation activity.

Product Branding

Product branding represents a large share of the billions spent on advertising annually. Companies that wish to brand on the Web will require rich media presentations at or beyond the standards placed on current television advertising. AdPix facilitates the dynamic and engaging advertisements necessary to attract and entice consumers.

AdPix's tiered incentive and compensation structure gives a varied array of benefits and rewards for different levels of interaction and clickthrough, thereby offering advertisers a payment structure in line with the derived benefits of the program.

Gross Revenue

The current media cost of banner space, even on more popular web sites, is at an all time low. AdPix allows advertisers to sell products and services using exciting, rich media presentations more akin to TV advertisements, while ensuring little to no waste and offering comprehensive profiling, tracking and monitoring services. Therefore, AdPix can demand higher advertising rates ranging from 15-50 cents per click, charging escalating fees for greater user interaction with an ad, product, or website.

| | |
|---|---|
| Individuals w/IMA/AdPix Accounts | 500,000 |
| Average Views per Day | 3 |
| Total Views per Day | 1,500,000 |
| Average Cost per Click (View) | $.25 |
| Daily “Click” Revenue | $375,000 |
| Average Monthly Gross “Click” Revenue | $12,500,000 |

Distribution Plan—Net Profits

Based on our knowledge and experience in the film and media industries, Visaeons has developed a comprehensive Media Distribution Plan for the dispersment of revenue resulting from the AdPix Model which maximizes net profits for Visaeons Corporation.

Further, the model strategically disseminates gross revenue from each AdPix viewing, incentivizing all chains of the distribution cycle to generate maximum profits.

Currently, advertisers pay an average of $250 per thousand-banner-ad-click-through with only very limited impact. AdPix system will allows advertisers to develop interactive, and keenly targeted presentations and advertisements to interested consumers. AdPix will charge rates similar to traditional click-through rates while offering advertisers a more targeted, effective and engaging advertising platform with no waste and far more trackable usage statistics.

Revenue generated from each AdPix viewing will breakdown as follows: Visaeons will charge an initial 25% distribution fee for each AdPix viewing or click-through. AdPix' distribution fee (25%) will be calculated as a percentage of the rate that advertisers pay to content providers for the consumer viewing. Visaeons will compensate the consumer viewing the ad or presentation with 30% of the ad's revenue. Visaeons will retain an additional 10% of the revenue to recover storage costs and overhead. In an effort to incentivize affiliates and content sites to encourage IMA registration and AdPix usage, the remaining 35% will be split between the affiliate site who originally signed-up the AdPix subscriber and the content site from which the consumer launched AdPix during the session in question.

| | |
|---|---|
| Revenue from single AdPix Viewing | .25 |
| Visaeons Distribution Fee | .075 |
| (30%) | |
| Visaeons Overhead Fee | .025 |
| (10%) | |
| Consumers Compensation | .075 |
| (30%) | |
| Affiliate and Launch Site Split | .0875 |
| (30%) | |
| Actual Storage and Overhead Costs | .02 |
| Visaeons Net Profit | .08 |

What is claimed is:

1. A computer implemented database system, capable of residing on several web sites that allows viewer/users to review potential advertising categories presented to them and if they so elect, choose to review a particular advertisement or several advertisements.
The viewers receive redeemable “points” for reviewing the ads. Said points accumulate and the viewer/user may; redeem those points through the system to purchase any number of products or services.
The system requires each viewer, in order to accumulate and redeem points, to register with the system and provide certain information which in turn helps the system and its advertising clients organize which advertisements to present as available first for a particular viewer. This profiling system is dynamic and accommodates on a regular basis the changing choices the viewer may make as well as the advertising mix that is available at any time on the system.
